(19) United States
(12) Patent Application Publication
(10) Pub. No.: US 2007/0229516 A1
(43) Pub. Date: Oct. 4, 2007

(54) Device, method and program for image processing

(75) Inventor: Mika Sugimoto, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/717,140

(22) Filed: Mar. 13, 2007

(30) Foreign Application Priority Data
Mar. 14, 2006 (JP) 2006-069845

(51) Int. Cl. G06T 15/70

(52) U.S. Cl. 345/473

(57) ABSTRACT

An image processing device for generating moving image data based on still images, comprising:

a display size detector that detects the display size of the moving image data;

a database that stores a moving image template prescribing a display condition corresponding to the display size of the moving image data; and

a moving image data generator that reads out, from the database, the moving image template prescribing the display condition corresponding to the display size detected by the display size detector and generates the moving image data based on the still images and the moving image template.

### BACKGROUND OF THE INVENTION

1. Field of the Invention

The present invention relates to technique for harmlessly displaying a dynamic moving image generated based on still images.

2. Description of the Related Art

When a display viewer gets stimuli from light that fast blinks on a display screen, the viewer suffers a known light-sensitive epileptic seizure by which a physical symptom such as a fit of convulsions are caused. As known, dynamic movement of an image on a display screen also causes a carsickness-like symptom for a viewer.

To address the above problems, according to the Japanese Patent Application Laid-Open No. 2000-232566, when a user moves a digital camera in case that the HAB (human augmented browser) is enabled in which displayed image content changes in conjunction with the movement of an electronics device itself, the image output to an external display device is stopped or image information is scaled. According to the “Accessibility Guidelines for provision of information using video, etc.”, Sumitomo Mitsui Banking Corporation, searched on Feb. 21, 2006 at the Internet URL [http://www.smbc.cojp/accessibility/guidelines/index_{—}07.html], in case of providing web content blinking a screen in a short cycle, a noticeable mark is shown around a link to that page so that a user can keep away from the link.

The Japanese Patent Application Laid-Open No. 2004-78927 discloses a slide show in which the suitable display time can be set depending on complexity of an image to be displayed. The Japanese Patent Application Laid-Open No. 2004-320379 discloses a slide show in which the display time can be set depending on the state of an image to be displayed.

In the past, a slide show was an application function for a personal computer; recently it is mounted even on a digital camera and a camera mobile phone. Moreover, a slide show is emerging with not only simple image switching effect, but also with dynamic motion like photo clipping.

Many digital cameras or mobile phones mount a function of outputting video to external devices. While nimble motion is played back smoothly on a small display screen such as that of a mobile phone, the motion, if it is played back on a large screen such as that of a television, can cause a carsickness-like symptom for a viewer.

### SUMMARY OF THE INVENTION

In view of the above problems, the present invention aims to create harmless moving images suitable for the status of a display screen.

The present invention provides an image processing device which generates moving image data based on still images, the device comprising: a display size detector which detects the display size of the moving image data; a database which stores a moving image template which prescribes a display condition corresponding to the display size of the moving image data; and a moving image data generator which reads out, from the database, the moving image template prescribing the display condition corresponding to the display size detected by the display size detector and generates the moving image data based on the still images and the moving image template.

According to this aspect of the present invention, the moving image data is generated based on the display condition corresponding to the display size of the detected moving image data. This enables the creation of a harmless moving image suitable for the status of the display screen.

The present invention also provides an image processing device which generates moving image data based on still images, the device comprising: a display size setting unit which sets the display size of the moving image data; a database which stores a moving image template containing a display condition corresponding to the display size of the moving image data; and a moving image data generator which reads out, from the database, the moving image template prescribing the display condition corresponding to the display size set by the display size setting unit and generates the moving image data based on the still images and the moving image template.

According to this aspect of the present invention, the moving image data is generated based on the display condition corresponding to the display size of the set moving image data. This enables the creation of a harmless moving image suitable for the status of the display screen.

The image processing device can further comprise a display unit which displays the moving image according to the moving image data generated by the moving image data generator.

The present invention also provides an image processing device which generates moving image data based on still images, the device comprising: an output destination detector which detects an output destination of video signals; a database which stores a moving image template containing a display condition corresponding to the output destination of the video signals; and a moving image data generator which reads out, from the database, the moving image template prescribing the display condition corresponding to the output destination of the video signals detected by the output destination detector and generates the moving image data based on the still images and the moving image template.

According to this aspect of the present invention, the moving image data is generated based on the display condition corresponding to the output destination of the detected video signals. This enables the creation of a harmless moving image suitable for the status of the output destination of the video signals.

The present invention also provides an image processing device which generates moving image data based on still images, the device comprising: an output destination detector which detects an output destination of video signals and the display size on the output destination of the video signals; a database which stores a moving image template containing a display condition corresponding to the output destination of the video signals and the display size on the output destination of the video signals; and a moving image data generator which reads out, from the database, the moving image template prescribing the display condition corresponding to the output destination of the video signals and the display size on the output destination of the video signals detected by the output destination detector and generates the moving image data based on the still images and the moving image template.

According to this aspect of the present invention, the moving image data is generated based on the display condition corresponding to the output destination of the detected video signals and the display size on the output destination. This enables the creation of a harmless moving image suitable for the status of the output destination of the video signals.

The device can further comprise a video output unit which outputs the video signals based on the moving image data generated by the moving image data generator to the output destination of the video signals detected by the output destination detector.

As an example, the display condition includes at least one of the motion speed and the maximum brightness of the still images.

The present invention also provides an image processing method of generating moving image data based on still images, the method including the steps of: detecting the display size of the moving image data; storing a moving image template prescribing a display condition corresponding to the display size of the moving image data in a database; and reading out, from the database, the moving image template prescribing the display condition corresponding to the detected display size and generating the moving image data based on the still images and the moving image template.

The present invention also provides an image processing method of generating moving image data based on still images, the method including the steps of: setting the display size of the moving image data; storing a moving image template containing a display condition corresponding to the display size of the moving image data in a database; and reading out, from the database, the moving image template prescribing the display condition corresponding to the set display size and generating the moving image data based on the still images and the moving image template.

The present invention also provides an image processing method of generating moving image data based on still images, the method including the steps of: detecting an output destination of video signals; storing a moving image template containing a display condition corresponding to the output destination of the video signals in a database; and reading out, from the database, the moving image template prescribing the display condition corresponding to the detected output destination of the video signals and generating the moving image data based on the still images and the moving image template.

The present invention also provides an image processing method of generating moving image data based on still images, the method including the steps of: detecting an output destination of video signals and the display size on the output destination of the video signals; storing a moving image template containing a display condition corresponding to the output destination of the video signals and the display size on the output destination of the video signals in a database; and reading out, from the database, the moving image template prescribing the display condition corresponding to the detected output destination of the video signals and the display size on the output destination of the video signals and generating the moving image data based on the still images and the moving image template.

The present invention also includes a computer program which causes a computer to execute the above image processing methods.

According to the present invention, the moving image data is generated based on the display condition corresponding to the detected or set display size of the moving image data, the detected output destination of the video signals or the display size on the output destination. This enables the creation of a harmless moving image suitable for the status of the display screen of the moving image.

### BRIEF DESCRIPTION OF THE DRAWINGS

FIG. 1 is an schematic block diagram illustrating a slide show creating device according to a first embodiment;

FIG. 2 is a conceptual diagram illustrating information accumulated by a template manager according to the first embodiment;

FIG. 3 is a flowchart illustrating one example of the flow of processing executed by the slide show creating device according to the first embodiment;

FIG. 4 is a flowchart illustrating another example of the flow of processing executed by the slide show creating device according to the first embodiment;

FIG. 5 shows one example of a screen to allow user to select the display size or the like for a moving image;

FIG. 6 is a conceptual diagram illustrating information accumulated by a template manager according to a second embodiment;

FIG. 7 is a flowchart illustrating one example of the flow of processing executed by the slide show creating device according to the second embodiment;

FIG. 8 is a flowchart illustrating another example of the flow of processing executed by the slide show creating device according to the second embodiment;

FIG. 9 is an overall block diagram illustrating an image recording device according to a third embodiment;

FIG. 10 is a conceptual diagram illustrating information accumulated by a template manager according to the third embodiment; and

FIG. 11 is a flowchart illustrating the flow of processing executed by the image recording device according to the third embodiment.

### DETAILED DESCRIPTION OF THE PREFERRED EMBODIMENTS

### First Embodiment

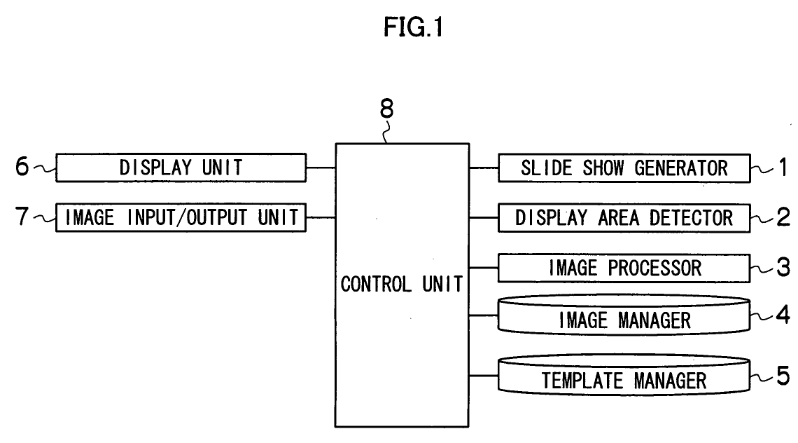

FIG. 1 is a block diagram illustrating a slide show creating device according to a preferred embodiment of the present invention. The slide show creating device comprises a control unit 8, a slide show generator 1, a display area detector 2, an image processor 3, an image manager 4, a template manager 5, a display unit 6 and image input/output unit 7.

The display area detector 2 detects the size of an available display area on the display unit 6 configured with an LCD monitor, for example.

The image manager 4 is storage media such as an HDD which accumulates a static image inputted by the image input/output unit 7 connected to a digital still camera, for example.

The slide show generator 1 generates moving image data in a format that can be played back by, for example, a mobile phone or a digital camera or moving image data including voice (slide show), based on one or more desired static images (for example, a JPEG format file; hereinafter referred to as an original image) selected by a user out of images accumulated by the image manager 4 and a display condition prescribed by a desired template selected out of templates stored in the template manager 5.

Examples of specific display conditions include the following: “effect” to switch between and display a plurality of still images in a random manner, display one or more still images so as to move on a screen at the predetermined speed, or produce motion of static images by switching between the plurality of still images like in a slide show; and a “composite frame” that is a static image or a dynamic moving image such as a flower or a window frame merged in a moving image. The template can also contain a playback condition of “background music (BGM)” played back in synchronization with the playback of the moving image data.

The moving image data can, once generated, be in a format different from the template such as an MP3 file, or a format for the moving image to be played back with both the still image such as an animation GIF and the template.

Although not described in detail, the template can also prescribe display states such as layout coordinates, the sizes or colors of various objects such as documents, characters or icons involved in the playback of the original image.

The template manager 5 is a database for accumulating templates and template management information.

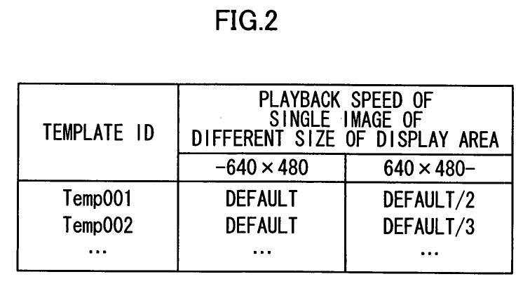

FIG. 2 shows one example of template management information stored in the template manager 5. As shown in FIG. 2, the template management information is the information prescribing the playback speed that depends on the display size of each original image in correspondence to identification information (ID) of each template.

The slide show generator 1 generates moving image data according not only to a display condition prescribed in a selected desired template, but also to the playback speed corresponding to ID of the selected template.

The image processor 3 generates video signals (for example, NTSC signals) adequate to the display prescription for the display unit 6 according to the moving image data generated by the slide show generator 1 and outputs the signals to the display unit 6.

The slide show creating device can be configured with, for example, a mobile phone or a digital camera; in this case, the display area detector 2 has only to detect the size of a display area on the display unit 6 built in the mobile phone or the like.

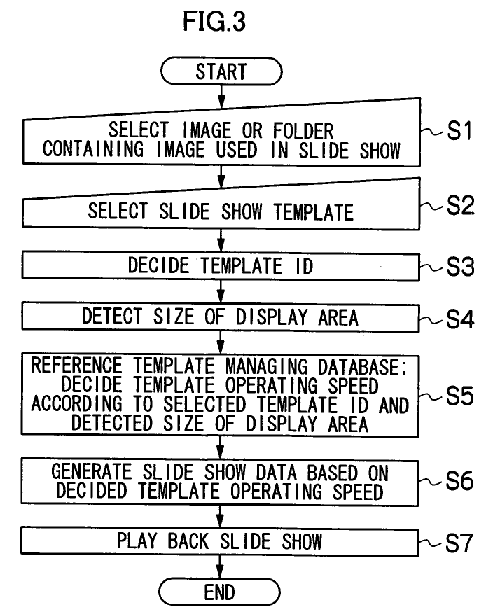

In the following, the flow of the processing by the device according to the present invention will be described with reference to FIG. 3.

In S1, in response to input operation by a user, original images used in a slide show are selected from the image manager 4. If it is cumbersome to designate the original images one by one, a folder storing the images can be selected and all images in that folder can be original images.

In S2, in response to the input operation by the user, a template prescribing a display condition for the slide show is selected from the template manager 5.

In S3, ID of the template prescribing the selected display condition is identified.

In S4, the display area detector 2 detects the size of an available display area on the display unit 6. The slide show generator 1 acknowledges the size of the display area detected by the display area detector 2 as the display size of the moving image.

In S5, the slide show generator 1, with reference to template management information in the template manager 5, decides the movement speed of the original image corresponding to the template ID identified in S3 and the display size of the moving image recognized in S4. For example, if template ID is “Temp001” and a display size is less than 640×480, the movement speed equals a pre-determined default value (for example, two pixels per second). In another case, if template ID is “Temp001” and the display size is more than 640×480, the movement speed equals (default value)/2 (for example, one pixel per second). In this way, the movement speed of the image depending on the display size of the moving image is reduced as the display size of the moving image is larger; otherwise the effect causing physical symptoms for a viewer becomes more powerful.

In S6, the slide show generator 1 creates moving image data in order to display and move each original image according to the movement speed decided in S5 and the display condition prescribed in the template selected in S3.

In S7, the image processor 3 generates video signals of the moving image displayed on the display unit 6 based on the generated moving image data and outputs the signals to the display unit 6. The display unit 6 inputs the video signals, and then displays the moving image at a decided movement speed.

As above, the slide show generator 1 creates the moving image data to change the movement speed of the original image depending on the display size of the available display area on the display unit 6. Since the original image is displayed and moved at the speed depending on the display size on the display unit 6, it becomes less likely to apply a viewer the excessive stimuli caused by the movement of the light sources to cause various physical symptoms.

The display area detector 2 does not have to always detect the display size on the display unit 6 automatically, but a user can also designate the display size of the moving image at will in order to create a moving image depending on the designated display size.

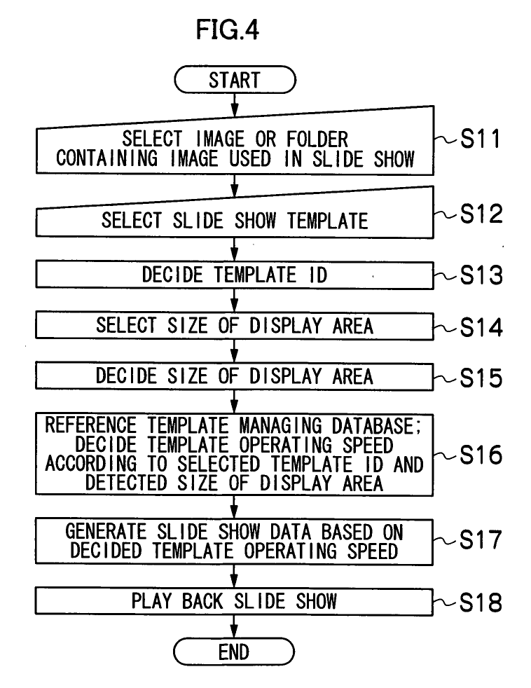

The flow of the processing by the device in the above case is illustrated in FIG. 4.

In S11, in response to input operation by a user, images used in a slide show are selected from the image manager 4.

In S12, in response to the input operation by the user, a template prescribing a desired display condition is selected from the template manager 5.

In S13, ID assigned to the selected template is identified.

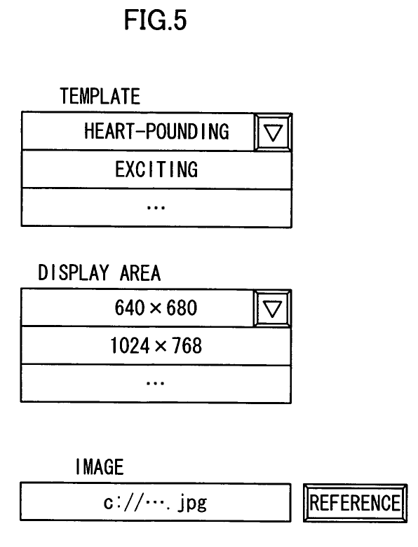

In S14, in response to the input operation by the user, the display size of the moving image is selected. For example, as shown in FIG. 5, the display size of the moving image desired by the user from a list of display sizes can be selected by the input operation. As shown in the figure, the images and the templates can also be selected from the same list on the screen.

In S15, the selected display size is acknowledged as the display size of the moving image on the display unit 6.

In S16, the slide show generator 1, with reference to the template management information, decides the movement speed of the original image corresponding to the template ID identified in S13 and the display size recognized in S15.

In S17, the slide show generator 1 creates moving image data to display and move each original image according to the display condition for the template selected in S12 and the movement speed decided in S16.

In S18, the image processor 3 generates video signals to display the moving image according to the selected display size based on the generated moving image data and outputs the signals to the display unit 6. The display unit 6 displays the moving image according to the selected display size as well as the decided movement speed.

In the above manner, if a user selects the display size of the moving image at will, a harmless slide show can be generated according to the size.

### Second Embodiment

In order to control excessive stimuli caused by light blinked and illuminated, it is effective to change the brightness depending on the display size of a screen.

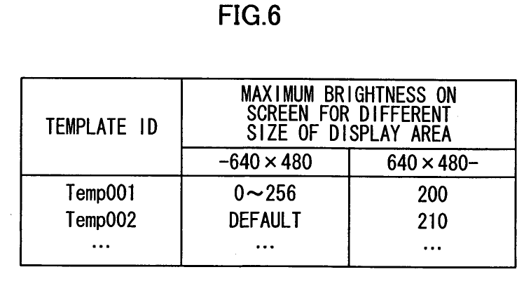

FIG. 6 shows one example of template management information stored in the template manager 5 according to a second embodiment. As shown in FIG. 6, the template management information in this embodiment maps template ID to the brightness depending on the size of a display area of each original image.

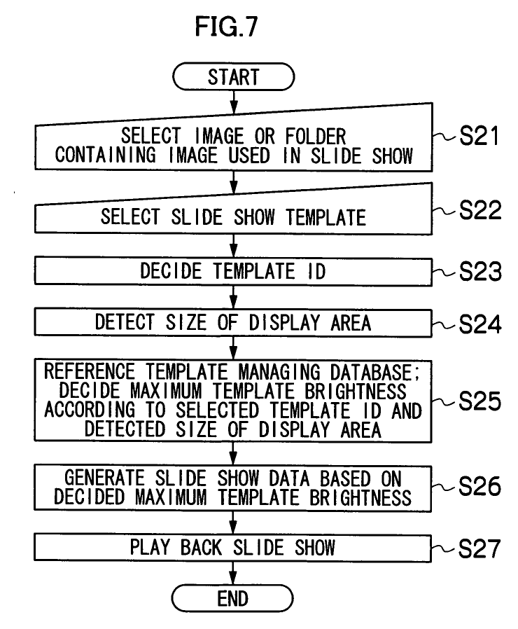

In the following, the flow of the processing by the device according to the present invention will be described with reference to FIG. 7.

In S21, in response to input operation by a user, images used in a slide show are selected from the image manager 4.

In S22, in response to the input operation by the user, a template prescribing a desired display condition is selected from the template manager 5.

In S23, ID of the selected template is identified.

In S24, the display area detector 2 detects the size of an available display area on the display unit 6. The slide show generator 1 acknowledges the display size detected by the display area detector 2 as the display size of the moving image.

In S25, the slide show generator 1, with reference to template management information, decides the maximum brightness for the slide show corresponding to the identified template ID and the display size of the recognized moving image. For example, if template ID is “Temp001” and the display size is less than 640×480, the maximum brightness equals a pre-determined default value between 0 and 256 (for example, 250). In another case, if template ID is “Temp001” and the display size is more than 640×480, the maximum brightness equals (default value)/2 (for example, 200). In this way, the display brightness on the screen depending on the display size is reduced as the display size is larger; otherwise the effect causing physical symptoms for a viewer becomes more powerful.

In S26, the slide show generator 1 creates moving image data such that each original image is displayed and moved under a display condition prescribed in the selected template and the decided maximum brightness.

In S27, the image processor 3 generates video signals based on the generated moving image data and outputs the signals to the display unit 6. The display unit 6 displays the moving image within the decided range of brightness.

In the above manner, the slide show generator 1 creates moving image data displayed within the range of brightness depending on the display size on the display unit 6. Since the moving image is displayed according to the brightness depending on the display size on the display unit 6, it becomes less likely to apply a viewer the excessive stimuli caused by the movement of the light sources of high brightness to cause various physical symptoms.

The display area detector 2 does not have to always detect the display size of the moving image automatically, but a user can also designate the display size.

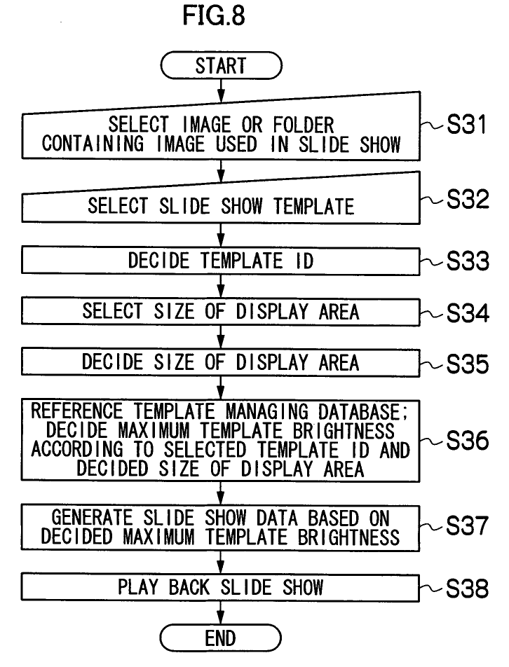

FIG. 8 illustrates the flow of processing by the device in the above case.

In S31, in response to input operation by a user, images used in a slide show are selected from the image manager 4.

In 532, in response to the input operation by the user, a template prescribing the slide show is selected from the template manager 5.

In S33, ID of the selected template is identified.

In S34, in response to the input operation by the user, the display size of the moving image is selected.

In S35, the selected display size is acknowledged as the display size of the moving image.

In S36, the slide show generator 1, with reference to the template management information, decides the maximum brightness corresponding to the identified template ID and the recognized display size of the moving image.

In S37, the slide show generator 1 creates moving image data to display and move each original image under the display condition for the selected template and the decided maximum brightness.

In S38, the image processor 3 generates video signals based on the generated moving image data and outputs the signals to the display unit 6. The display unit 6 displays and moves the moving image under the maximum brightness.

### Third Embodiment

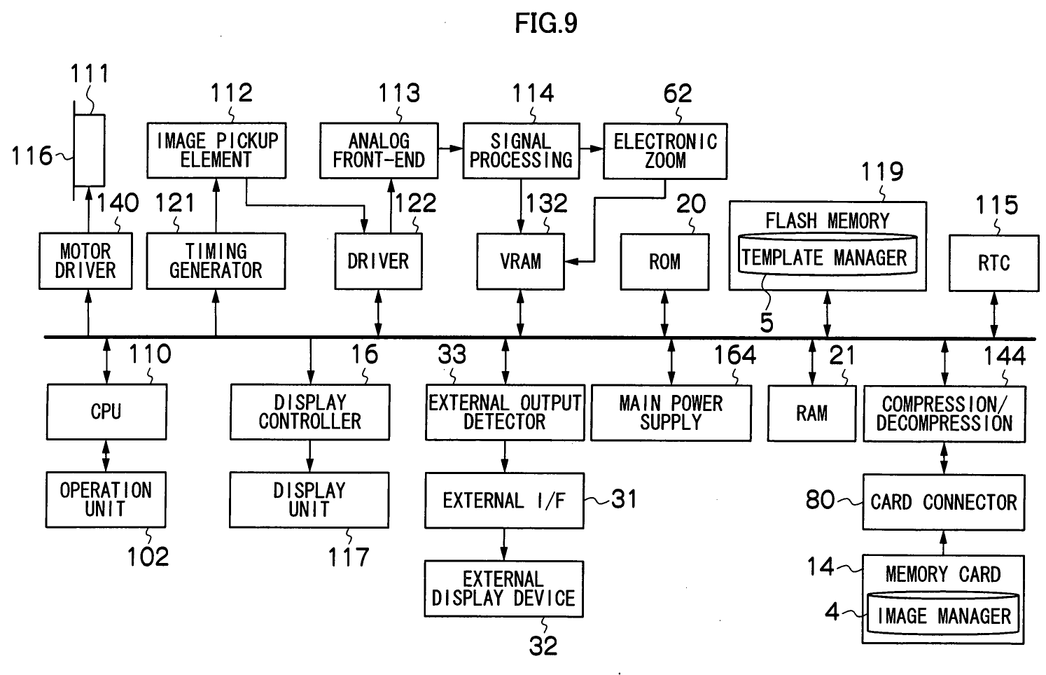

FIG. 9 is a functional block diagram of an image recording device according to a third preferred embodiment of the present invention. The image recording device comprises an imaging lens 111, a solid-state imaging element 112 such as a CCD, an analog front-end circuit 113 which processes an analog image read by a driver 122 from the solid-state imaging element 112 to digital signals, a signal processing circuit 114 such as a DSP (Digital Signal Processor) which processes the digital image signals from the analog front-end circuit 113, a central processing unit (CPU) 110, a display controller 16 which controls display of a display unit 117, for example. Power is supplied to each circuit in the image recording device from a main power supply 164 consisting of a battery attached within chassis of the image recording device. An RTC (Real Time Clock) 115 is a chip dedicated to timing, which operates with power supplied from another battery even if the main power supply 164 of the image recording device is powered off.

The image recording device also comprises a card connector 80 which reads data from a memory card 14 and records data in the memory card 14, an embedded flash memory 119 in which recorded content can be rewritten, a ROM 20 which stores various data and programs, and a RAM 21 which stores various data necessary for processing by the CPU 110. The above units are connected to one another via a bus.

As the imaging lens 111, a 2× optical zoom lens is used, for example. An optical zoom factor changes as a motor driver 140 shifts the imaging lens 111 to a telephoto (tele) side or a wide-angle (wide) side depending on zoom factor changing operation inputted from an operating unit 102. The zoom factor of the imaging lens 111 is not limited to the above. The imaging lens 111 is provided with a diaphragm 116 so that it controls the diaphragm 116 through the motor driver 140 to achieve adequate light exposure.

When the operating unit 102 sets to image pickup mode, the CPU 110 displays a moving image (through-the-lens image) on the display unit 117, making an imaging field angle checkable. That is, the solid-state imaging element 112 converts subject light formed on an acceptance surface of the imaging lens 111 to signal electric charge of an amount depending on its light amount. The signal electric charge of each pixel accumulated in this way is read separately and sequentially by the driver 122 as power voltage signals (image signals) depending on the signal electric charge based on drive pulses given from a timing generator 121 according to an indication by the CPU 110, converted to digital signals in the analog front-end circuit 113 and applied to the signal processing circuit 114.

The signal processing circuit 114 is a device which processes images and includes a gain adjusting circuit and an A/D converter and further includes a brightness and color difference signal generating circuit, a gamma correction circuit, a sharpness correction circuit, a contrast correction circuit, a white balance correction circuit, an outline processor that performs image processing including outline correction on a picked-up image, a noise reduction processor which performs noise reduction on the image, or the like, and processes image signals according to a command from the CPU 110.

Image data inputted to the signal processing circuit 114 is converted to brightness signals (Y signals) and color difference signals (Cr and Cl signals), and after pre-determined processing such as gamma correction is performed on it, stored in a VRAM 132.

In the case of outputting the picked-up image on the display unit 117 as a monitor, YC signals are read from the VRAM 132 and sent to the display controller 16. The display controller 16 converts the inputted YC signals to signals of pre-determined system for display (for example, color complex video signals of the NTSC system) and outputs the signals to the display unit 117.

The image data in the VRAM 132 is provided to an electronic zoom circuit 62 from the signal processing circuit 114 as necessary. The electronic zoom circuit 62 performs scaling processing on the image. The scaling processing is achieved by clipping part of the image data and scaling the clipped range. Then, the circuit 62 outputs the scaled image data to the VRAM 132. The clipped range can be moved to any position on the image by operation with the operating unit 102 such as arrow buttons, so that desired range of the image data can be scaled.

YC signals of each frame processed at the pre-determined frame rate are written alternately on A and B regions in the VRAM 132. The written YC signals are read from one of the A and B regions in the VRAM 132 in which the YC signals are not written. In this manner, the YC signals in the VRAM 132 is rewritten periodically and video signals generated from the YC signals are supplied to the display unit 117, so that video being imaged is displayed on the display unit 117 in real time. A user can check an imaging field angle by means of video (through-the-lens one) displayed on the display unit 117.

During the above processing, when an image pickup key equipped on the operating unit 102 is pushed, image pickup operation starts for recording. Image data acquired in conjunction with the pushing down of the image pickup key is converted to brightness/color difference signals (Y/C signals) in the signal processing circuit 114, and after pre-determined processing such as gamma correction is performed on it, stored in the RAM 21.

The Y/C signals stored in the RAM 21 is compressed according to a pre-determined format by a compression/decompression processing circuit 144, and then recorded in the memory card 14 via the card connector 80 as an image file of the pre-determined format such as an Exif file.

When the operating unit 102 sets to moving image pickup mode, moving image recording operation starts in conjunction with the push-down operation of the image pickup key, and when the image pickup key is pushed down again, the moving image recording operation stops. The recording operation can be performed during the continuing push-down of the image pickup key, and stopped at the time of release of the push-down. The moving image data is recorded, for example in a motion JPEG (MPEG) format in the memory card 14 as one aspect of the first storage unit according to the present invention.

When the operating unit 102 sets to playback mode, compression data of a final image file (last recorded file) is read that is recorded in the memory card 14. If the file related to the last recording is a still image file, the read image compression data is decompressed to un-compressed YC signals through the compression/decompression processing circuit 144 and saved in the VRAM 132. The YC signals saved in the VRAM 132 are provided to the display controller 16. The display controller 16 produces RGB color complex video signals of an NTSC system from inputted YC signals and outputs the signals to the display unit 117. In this manner, the display unit 117 displays a frame image of the final frame recorded in the memory card 14.

After the above processing, when a right key among the arrow keys equipped on the operating unit 102 is pushed, the images are advanced to a forward direction frame-by-frame, and when a left key among the arrow keys is pushed, the images are advanced to a backward direction frame-by-frame. Then, an image file at an advanced frame position is read from the memory card 14 and the frame image is played back on the display unit 117 similarly to the above. If the image is advanced frame-by-frame to the forward direction while a frame image of the final frame is displayed, an image file of the first frame recorded in the memory card 14 is read and the frame image of the first frame is played back on the display unit 117.

Various files such as image files can also be stored in the flash memory 119. If the flash memory 119 stores an image file, it is preferable to prepare capacity by considering the pixel size and number of an image to be stored. The use of the flash memory 119 is not necessarily limited to file storage, but the memory 119 can also be used to be migrated with, for example data stored in the VRAM 132 in emergency such as on the occurrence of a trouble of the main power supply 164.

The pixel number of the image file to be store is, for example, one of 2832×2128 (6M), 2048×1536 (3M), 1280×960 (1M) and 640×480 (VGA), and the amount of data (file size) changes with the picked-up image by the combination of the quality of the recorded image and the number of recorded pixels.

The image recording device comprises an external interface 31 to output image signals through the connection to an external display device 32 configured with, for example an external monitor or a typical television and an external output detector 33 which detects the size of an available display area on the external display device 32. The external output detector 33 has a function similar to the display area detector 2 according to the first embodiment.

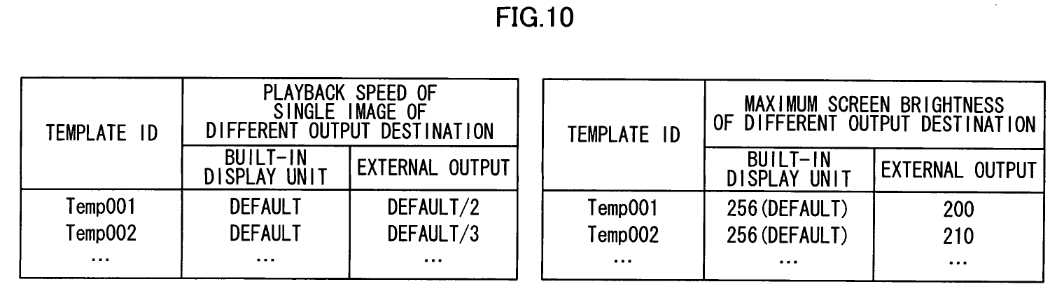

As illustrated in FIG. 10, the flash memory 119 accumulates template management information having the same content as the template manager 5. However, the template management information prescribes the playback speed and maximum brightness for the image corresponding to template ID and an output destination (i.e., the built-in display unit 117 or the external display device 32 as an external output destination) of video signals of the moving image. The memory card 14 also accumulates information having the same content as the image manager 4.

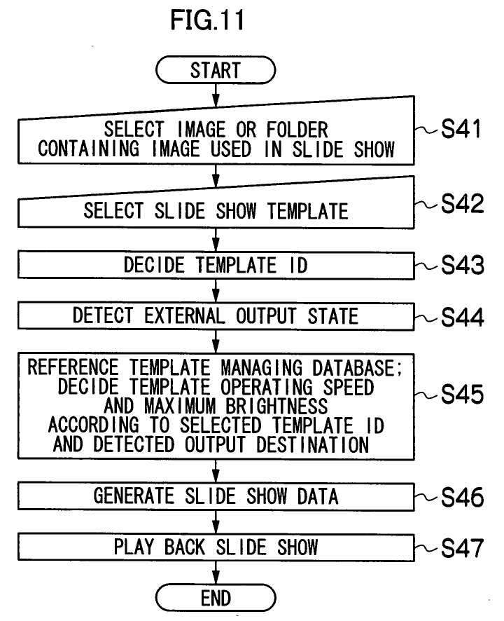

In the following description, the flow of the processing by the device according to the present invention will be described with reference to FIG. 11.

In S41, in response to input operation by a user, images used in a slide show are selected from the image manager 4.

In S42, in response to the input operation by the user, a template prescribing a desired display condition is selected from the template manager 5.

In S43, ID of the selected template is identified.

In S44, the external output detector 33 detects which one of the display unit 117 or the external display device 32 has been selected by the user operation as an output destination of video signals. Similarly to the first embodiment, the external output detector 33 can also detect the size of an available display area on the detected output destination. The CPU 110 recognizes the output destination detected by the display area detector 2. If the size of the available display area on the output destination detected by the external output detector 33 has been detected, the CPU 110 acknowledges the size as the display size of the moving image.

In S45, the CPU 110 decides, with referencing to the template management information, the movement speed and the maximum brightness of the original image corresponding to the identified template ID and the recognized output destination. For example, if the template ID is “Temp001” and the recognized output destination is the display unit 117 (the size of its available display area is, for example less than 640×480), the movement speed equals a pre-determined default value (for example, two pixels per second) and the maximum brightness equals a pre-determined default value between 0 and 256 (for example, 250). In another case, if the template ID is “Temp001” and the recognized output destination is the external display device 32 (the size of its available display area is, for example more than 640×480), the movement speed equals (default value)/2 (for example, one pixel per second) and the maximum brightness equals 200.

In S46, the CPU 110 creates moving image data such that each original image is displayed and moved under a display condition prescribed in the selected template and the decided movement speed and maximum brightness.

In S47, the display controller 16 generates video signals that can be displayed on the output destination selected out of the display unit 117 and the external display device 32 based on the generated moving image data, and outputs the signals on the destination selected out of the display unit 117 and the external display device 32. The display unit 117 or the external display device 32 displays and moves the moving image within the range of the decided movement speed and the highest brightness.

As described in the above, since the original image is displayed and moved at the speed and the maximum brightness decided depending on the display size on the destination selected out of two displaying devices: the display unit 117 and the external display device 32, it becomes less likely to cause various physical symptoms that applied a viewer the excessive stimuli caused by the blinking and movement of light sources.

Although the external display device 32 can be of various types as conveniently to a viewer, in this case a moving image (slide show) is generated at the suitable speed and the brightness depending on each external display device 32, and any of the external display devices 32, which can change in various way, can display the moving image in a harmless manner.

What is claimed is:

1. An image processing device for generating moving image data based on still images, comprising:
a display size detector that detects the display size of the moving image data;
a database that stores a moving image template prescribing a display condition corresponding to the display size of the moving image data; and
a moving image data generator that reads out, from the database, the moving image template prescribing the display condition corresponding to the display size detected by the display size detector and generates the moving image data based on the still images and the moving image template.

2. An image processing device for generating moving image data based on still images, comprising:
a display size setting unit that sets the display size of the moving image data;
a database that stores a moving image template containing a display condition corresponding to the display size of the moving image data; and
a moving image data generator that reads out, from the database, the moving image template prescribing the display condition corresponding to the display size set by the display size setting unit and generates the moving image data based on the still images and the moving image template.

3. The image processing device according to claim 1, further comprising: a display unit that displays the moving image according to the moving image data generated by the moving image data generator.

4. The image processing device according to claim 2, further comprising: a display unit that displays the moving image according to the moving image data generated by the moving image data generator.

5. An image processing device for generating moving image data based on still images, comprising:
an output destination detector that detects an output destination of video signals;
a database that stores a moving image template containing a display condition corresponding to the output destination of the video signals; and
a moving image data generator that reads out, from the database, the moving image template prescribing the display condition corresponding to the output destination of the video signals detected by the output destination detector and generates the moving image data based on the still images and the moving image template.

6. An image processing device for generating moving image data based on still images, comprising:
an output destination detector that detects an output destination of video signals and the display size on the output destination of the video signals;
a database that stores a moving image template containing a display condition corresponding to the output destination of the video signals and the display size on the output destination of the video signals; and
a moving image data generator that reads out, from the database, the moving image template prescribing the display condition corresponding to the output destination of the video signals and the display size on the output destination of the video signals detected by the output destination detector and generates the moving image data based on the still images and the moving image template.

7. The image processing device according to claim 5, further comprising: a video output unit which outputs video signals based on the moving image data generated by the moving image data generator to the output destination of the video signals detected by the output destination detector.

8. The image processing device according to claim 6, further comprising: a video output unit which outputs video signals based on the moving image data generated by the moving image data generator to the output destination of the video signals detected by the output destination detector.

9. The image processing device according to claim 1, wherein the display condition includes at least one of the motion speed and the maximum brightness of the still images.

10. The image processing device according to claim 2, wherein the display condition includes at least one of the motion speed and the maximum brightness of the still images.

11. The image processing device according to claim 5, wherein the display condition includes at least one of the motion speed and the maximum brightness of the still images.

12. The image processing device according to claim 6, wherein the display condition includes at least one of the motion speed and the maximum brightness of the still images.

13. An image processing method of generating moving image data based on still images, including the steps of:
detecting the display size of the moving image data;
storing a moving image template prescribing a display condition corresponding to the display size of the moving image data in a database; and
reading out, from the database, the moving image template prescribing the display condition corresponding to the detected display size and generating the moving image data based on the still images and the moving image template.

14. An image processing method of generating moving image data based on still images, including the steps of:
setting the display size of the moving image data;
storing a moving image template containing a display condition corresponding to the display size of the moving image data in a database; and
reading out, from the database, the moving image template prescribing the display condition corresponding to the set display size and generating the moving image data based on the still images and the moving image template.

15. An image processing method of generating moving image data based on still images, including the steps of:
detecting an output destination of video signals;
storing a moving image template containing a display condition corresponding to the output destination of the video signals in a database; and
reading out, from the database, the moving image template prescribing the display condition corresponding to the detected output destination of the video signals and generating the moving image data based on the still images and the moving image template.

16. An image processing method of generating moving image data based on still images, including the steps of:
detecting an output destination of video signals and the display size on the output destination of the video signals;
storing a moving image template containing a display condition corresponding to the output destination of the video signals and the display size on the output destination of the video signals in a database; and
reading out, from the database, the moving image template prescribing the display condition corresponding to the detected output destination of the video signals and the display size on the output destination of the video signals and generating the moving image data based on the still images and the moving image template.

17. A computer program that causes a computer to execute the image processing method according to claim 13.

18. A computer program that causes a computer to execute the image processing method according to claim 14.

19. A computer program that causes a computer to execute the image processing method according to claim 15.

20. A computer program that causes a computer to execute the image processing method according to claim 16.
